(19) United States
(12) Patent Application Publication
(10) Pub. No.: US 2015/0121731 A1
(43) Pub. Date: May 7, 2015

(54) Traffic Control Paddle With Extendable Rod Handle

(71) Applicant: Exodus Traffic Systems Ltd., Maple Ridge (CA)

(72) Inventor: Desiree FLAMING, Maple Ridge (CA)

(21) Appl. No.: 14/531,870

(22) Filed: Nov. 3, 2014

Related U.S. Application Data
(60) Provisional application No. 61/899,267, filed on Nov. 3, 2013.

(51) Int. Cl. G09F 7/20; G09F 21/02; G09F 13/00; G09F 15/00

(52) U.S. Cl. CPC G09F 7/20; G09F 15/0087; G09F 21/026; G09F 13/00; G09F 15/005; G09F 2007/1878
USPC 40/541; 40/586

(57) ABSTRACT

A paddle for traffic control having a display sign having two opposing display sides; a unitary handle comprising a plurality of telescoping tubes, the handle having opposing ends, the first end reversibly attachable to the display sign, said handle adjustable between a fully extended position and a plurality of collapsed positions; handle adjustment means comprising a twist lock mechanism to convert the paddle between discrete positions; one or more LED lights attached to the handle; and a base plate attached to the second end of the handle.

### FIELD OF THE INVENTION

The present invention relates to safety products. In particular, the present invention relates to handheld traffic control signage.

### BRIEF DESCRIPTION OF THE DRAWINGS

A detailed description of the preferred embodiments is provided below by way of example only and with reference to the following drawings, in which:

FIG. 1 depicts a front plan view of one embodiment of the present invention in a retracted position;

FIG. 2 depicts a front plan view of one embodiment of the present invention in an extended position, with 18 inch long rod extension segments;

FIG. 3 depicts a second embodiment of the present invention in an extended position having 11 inch long rod extension segments; and

FIG. 4 depicts a traffic control flag person using the present invention in an extended position.

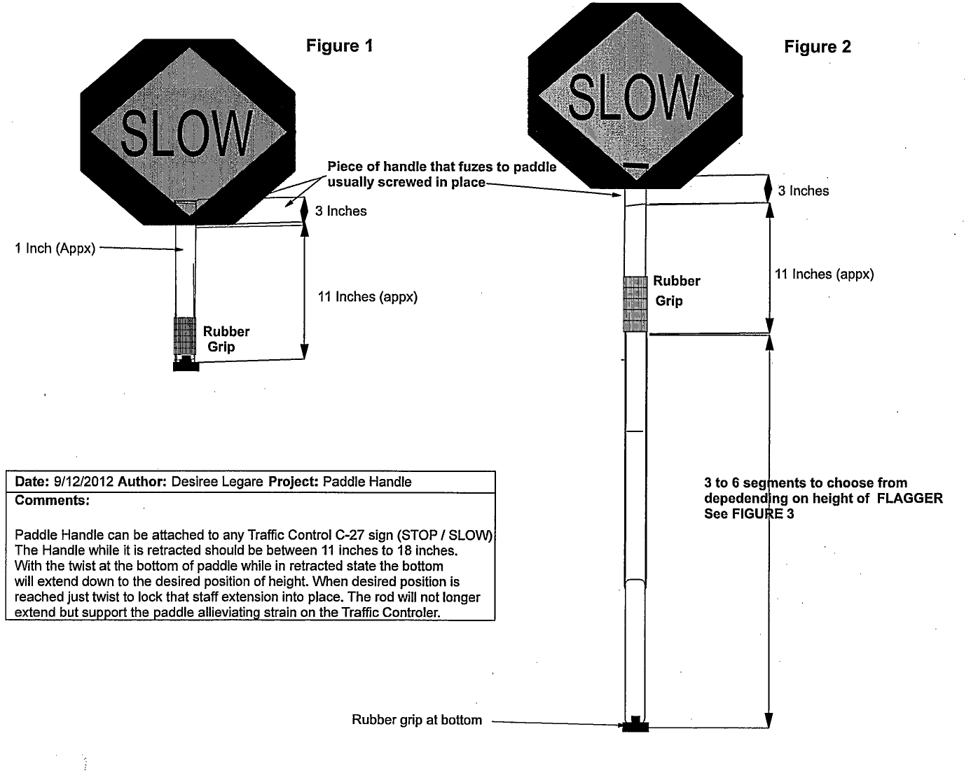

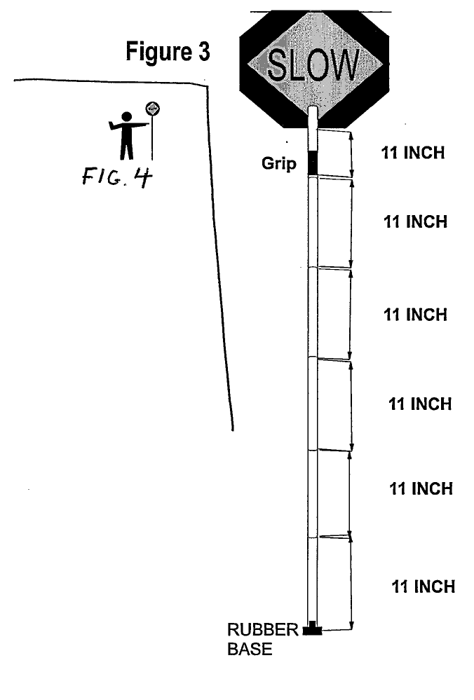

In the drawings, one embodiment of the invention is illustrated by way of example. It is to be expressly understood that the description and drawings are only for the purpose of illustration and as an aid to understanding, and are not intended as a definition of the limits of the invention.

### DESCRIPTION OF THE PRESENT INVENTION

There is provided an adjustable traffic control paddle for controlling vehicle movement during emergencies, road construction, public events, or other activities. The paddle has a unitary extendible handle which permits use of the paddle in a short handle form, and in a long handle form.

It is known in the prior art to have short handle paddles and separate long handle paddles, and also to have separate handle extension elements which may be used to build a long handled paddle from a short handled paddle. However, the prior art does not include a traffic control paddle having a unitary handle which may be transitioned between a short handle and a long handle.

The ability to immediately convert between short and long handles on the traffic control paddle permits the traffic control person to remain in place without having to return to a vehicle or other equipment storage location. It also ensures that no separate pieces are required as such elements may be misplaced or lost, preventing full use of the traffic control paddle.

Preferably, the paddle and rod are manufactured of plastic, but other materials are also within the scope of the invention. The rod may also include a grip made of rubber or other high friction material, the grip positioned preferably on the handle element attached to the traffic control sign.

In a preferred embodiment, the rod is 1 inch in diameter, and includes a first rod element of which the uppermost 3 inches attach to the traffic control paddle with screws or other attachment means. Each additional rod extension element preferably is between 11 and 18 inches in length, with the lowermost rod extension element having a base plate, preferably of rubber, for resting the paddle on the ground or other surface. The base plate may be twisted to unlock the rod extension elements, then retwisted in the opposite rotational direction to relock the rod extension elements once the handle is a desired length.

According to one embodiment, the extendable rod combines 6 segments, each 11 inches in length. The nested extension segments may be set to any desired length then twisted to lock at that length.

The paddle handle may be attached to any Traffic Control C-27 sign (STOP/SLOW). In its retracted position, the handle will be between 11 and 18 inches long. Once the handle is extended and twisted to lock in at a desired length, the paddle may be rested on the handle to alleviate strain on the Traffic Control Person.

In operation, the rod extension elements are nested in a telescoping manner. A twist and lock mechanism as known in the prior art is used to loosen the rod extension elements in the shortened handle. The handle is twisted in a first unlocking direction, one or more extension elements of the rod are pulled out until the handle is a desired length, then each rod extension element is twisted in a locking direction into the adjoining element to lock it in place.

The traffic control paddle preferably may display the word ‘STOP’ on one face and the word ‘SLOW’ on the opposing face. It is also within the scope of the invention to display other words or symbols on one or both faces of the paddle as the traffic control activities require.

According to one embodiment, there is provided one or more LED lights along the handle to permit vehicle operators to more easily see the traffic control person and to allow the traffic control person to indicate to the vehicle operator the direction of travel, a hazard to avoid, or signal the location to stop.

From the foregoing, it will be seen that this invention is one well adapted to attain all of the ends and objectives herein set forth, together with other advantages which are obvious and which are inherent to the apparatus. It will be understood that certain features and sub-combinations are of utility and may be employed with reference to other features and sub-combinations. As many possible embodiments may be made of the invention without departing from the scope of the claims, it is to be understood that all matter herein set forth or shown in the accompanying drawings is to be interpreted as illustrative and not in a limiting sense. It will be appreciated by those skilled in the art that other variations of the preferred embodiment may also be practised without departing from the scope of the invention.

1. A paddle for traffic control having:
a. a display sign having at least one display side;
b. a unitary handle having opposing ends, the first end reversibly attachable to the display sign, said handle adjustable between a fully extended position and a plurality of collapsed positions;
c. handle adjustment means to convert the paddle between discrete positions; and
d. a base plate attached to the second end of the handle.

2. The paddle of claim 1, wherein the handle comprises a plurality of telescoping tubes.

3. The paddle of claim 2 wherein the handle comprises six telescoping tubes each 11 inches in length.

4. The paddle of claim 1, wherein the handle adjustment means comprises a twist lock mechanism.

5. The paddle of claim 4 wherein the handle adjustment means is actuated by rotating the base plate.

6. The paddle of claim 1 further comprising one or more lights attached to one or more positions along the handle.

7. The paddle of claim 6, wherein the one or more lights are LED lights.

8. The paddle of claim 1 wherein the display sign comprises two opposing display sides.

9. The paddle of claim 8 wherein the display sign displays the word “STOP” on the first display side and the word “SLOW” on the opposing second display side.

10. A paddle for traffic control having:
a. a display sign having two opposing display sides;
b. a unitary handle comprising a plurality of telescoping tubes, the handle having opposing ends, the first end reversibly attachable to the display sign, said handle adjustable between a fully extended position and a plurality of collapsed positions;
c. handle adjustment means comprising a twist lock mechanism to convert the paddle between discrete positions;
d. one or more LED lights attached to the handle; and
e. a base plate attached to the second end of the handle.
